(19) United States
(12) Patent Application Publication
(10) Pub. No.: US 2012/0105986 A1
(43) Pub. Date: May 3, 2012

(54) HOUSING STRUCTURE FOR MINIATURE LENS FOCUS MODULE

(76) Inventors: Fu-Yuan Wu, Yangmei Taoyuan (TW); Shang-Yu Hsu, Yangmei Taoyuan (TW)

(21) Appl. No.: 12/917,261

(22) Filed: Nov. 1, 2010

(51) Int. Cl. G02B 7/04

(52) U.S. Cl. 359/823

(57) ABSTRACT

A housing structure for miniature lens focus module has a top portion formed into a stepped structure, that is, the housing has a size-reduced topmost portion relative to the rest rear portion thereof and has a shoulder portion formed therein, so that a plate-shaped spring element for holding a lens holder can be directly connected to the shoulder portion in the housing to keep away from the topmost portion of the housing by a predetermined distance and define an operation space between the shoulder portion and the topmost portion, allowing the lens holder and accordingly a lens held thereto to axially linearly move within the operation space to focus light. The spacer provided in the prior art lens focus module can be omitted to reduce the cost and the assembling procedures of the lens focus module.

### FIELD OF THE INVENTION

The present invention relates to a housing structure for miniature lens focus module, and more particularly to a miniature lens auto-focus module that includes a housing having a stepped top portion to define a shoulder portion therein, so that a spring plate of the auto-focus module is directly connected to the shoulder portion in the housing to space from the top portion of the housing by a predetermined distance, within which the lens connected to the spring plate is linearly movable.

### BACKGROUND OF THE INVENTION

With the progress in scientific technologies and the modularization and miniaturization of camera lens, it is now possible to produce digital cameras having a very small volume, and most of currently available mobile phones are provided with the function of a digital camera. In a miniature lens, there are many different auto-focus driving mechanisms. Among others, the voice coil motor (VCM) is the currently most widely employed auto-focus driving structure. The VCM has the advantages of small volume, low power consumption, accurately actuated displacement, and cost-effective, and is therefore very suitable for short-distance driving in miniature lens auto-focusing.

FIGS. 1 and 2 are exploded and assembled perspective views, respectively, of part of a conventional VCM lens auto-focus module, and FIG. 3 is a sectional view taken along line A-A of FIG. 2. The conventional lens auto-focus module includes a housing 1, a spring plate 2, and a spacer 3. The spring plate 2 is disposed in the housing 1, and has an outer fixed portion and an inner movable portion. The inner movable portion is connected to a lens holder (not shown), and a lens (not shown) is held in the lens holder.

Since there must be a distance existed between the housing 1 and the spring plate 2 to provide an operation space for the lens to move therein, the spacer 3 is disposed between the housing 1 and the spring plate 2 to define the operation space. That is, the outer fixed portion of the spring plate is fixed to the spacer 3, so that the lens can move forward or rearward within the operation space formed between the housing 1 and the spring plate 2 to achieve the purpose of auto-focusing.

With the above structure, the spacer 3 must be additionally provided to inevitably increase the manufacturing cost and the assembling procedure of the lens auto-focus module. It is therefore tried by the inventor to develop an improved housing structure for the spring plate to fixed thereto without the need of an additional spacer while there is an operation space formed between the housing and the spring plate for the lens to move and focus, so that the cost and the procedure for manufacturing and assembling the lens auto-focus module can be reduced.

### SUMMARY OF THE INVENTION

A primary object of the present invention is to provide a housing structure for lens focus module, so that the spacer used in the prior art lens focus module can be saved to reduce the cost and the assembling procedure of the lens focus module.

To achieve the above and other objects, the housing structure for lens focus module according to the present invention has a top formed into a stepped structure, so that the housing has a size-reduced topmost portion relative to the rest rear portion thereof and has a shoulder portion formed therein to define an operation space between the shoulder portion and the topmost portion, and a spring element of the lens focus module is directly connected to the shoulder portion in the housing to keep away from the topmost portion of the housing by the operation space, allowing a lens connected to the spring element to axially linearly move within the operation space.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of part of a conventional VCM lens auto-focus module;

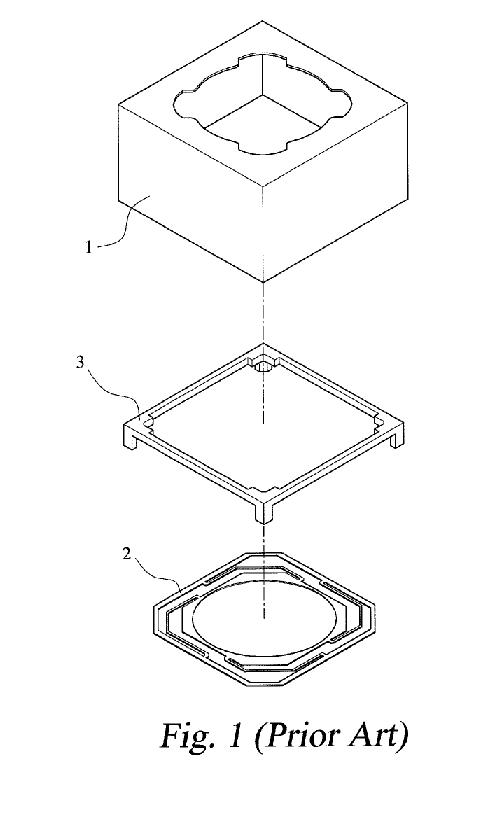

FIG. 2 is an assembled view of FIG. 1;

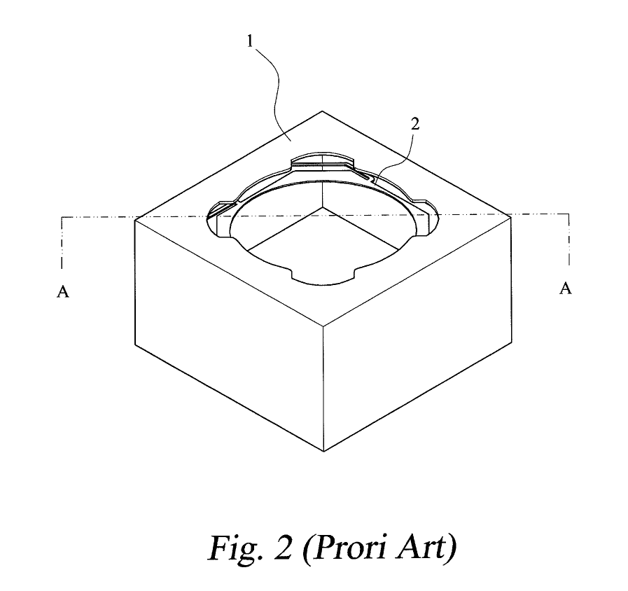

FIG. 3 is a sectional view taken along line A-A of FIG. 2;

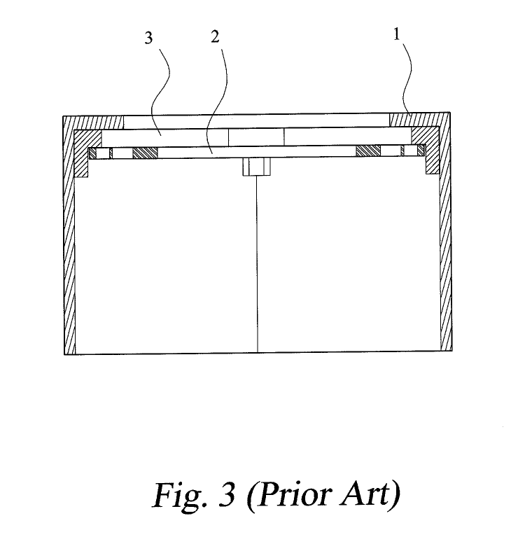

FIG. 4 is an exploded perspective view of a miniature lens focus module with a housing structure according to an embodiment of the present invention;

FIG. 5 is a perspective view of the housing structure for miniature lens focus module according to the present invention with a spring plate assembled thereto; and

FIG. 6 is a sectional view taken along line B-B of FIG. 5.

### DETAILED DESCRIPTION OF THE PREFERRED EMBODIMENTS

The present invention will now be described with a preferred embodiment thereof and with reference to the accompanying drawings. It is understood the accompanying drawings are illustrated only for assisting in describing the present invention and not intended to limit the present invention.

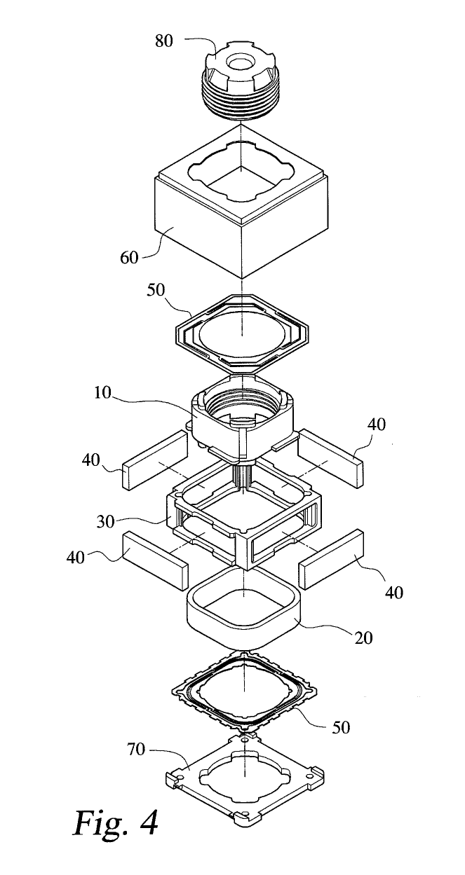

Please refer to FIG. 4 that is an exploded perspective view of a miniature lens focus module with a housing structure according to an embodiment of the present invention. As shown, the miniature lens focus module includes a lens holder 10, a winding element 20, a frame 30, four magnetic elements 40, at least one spring plate 50, a housing 60, a lower cover 70, and a lens 80.

The lens holder 10 defines an axially extended hollow central hole for holding the lens 80 therein. The axial central hole of the lens holder 10 is internally threaded for meshing with external threads on the lens 80, so that the lens 80 is firmly screwed to the axial hole of the lens holder 10. The winding element 20 is externally provided around the lens holder 10.

The frame 30 is a substantially square hollow member with four vertical side walls, each of which has an opening for one of the four magnetic elements 40 to set therein. The four magnetic elements 40 can be, for example, four magnets. The lens holder 10 is centered in the hollow frame 30, such that the lens holder 10 can only linearly move in the frame 30 along a light entering path.

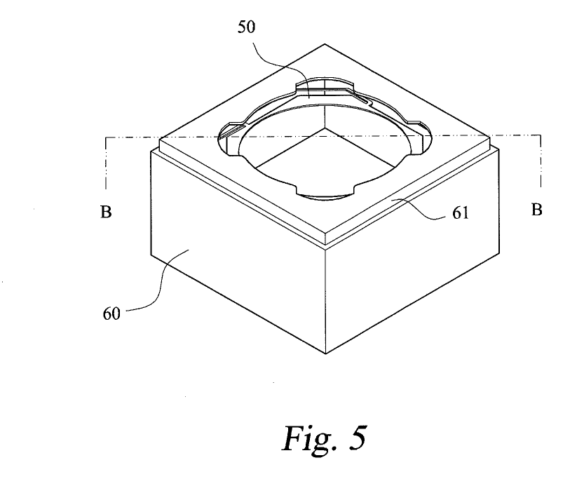

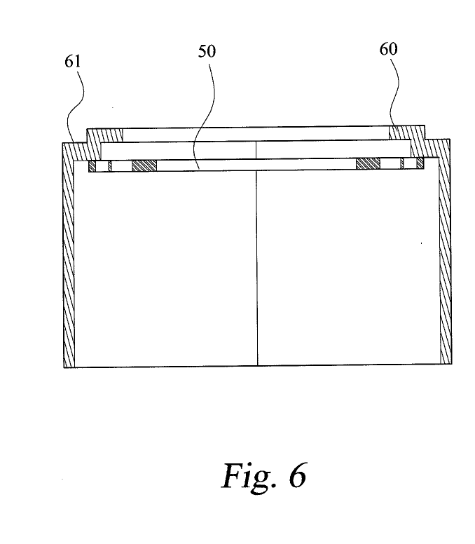

Please refer to FIG. 5 that is a perspective view of the housing 60, and to FIG. 6 that is a sectional view taken along line B-B of FIG. 5 for showing the structure of the housing 60. As shown, the housing 60 includes a top formed into a stepped structure 61. That is, the housing 60 has a size-reduced topmost portion relative to the rest rear portion of the housing 60, such that a shoulder portion is formed in the housing 60 and a predetermined distance is defined between the shoulder portion and the topmost portion. The stepped structure 61 is so sized that the spring element 50 can be directly internally connected to the shoulder portion in the housing 60 to keep away from the topmost portion of the housing 60 by the predetermined distance, and an operation space is defined between the topmost portion and the spring element 50, allowing the lens 80 to linearly move along the light entering path in the operation space.

Preferably, the housing 60 is made of a metal material for covering the whole lens focus module therein, so as to prevent electromagnetic interference and achieve the purpose of electrostatic protection.

With the housing structure of the present invention, the cost of manufacturing an additional spacer can be saved, and the procedure of assembling the additional spacer can be omitted. Thus, the present invention provides a novel, improved and industrially useful technical design that is completely different from the prior art.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A housing structure for lens focus module, the lens focus module comprising at least a frame being a square hollow member having four vertical side walls with an opening each; four magnetic elements being separately set in the openings of the side walls of the frame; a lens holder defining an axially extended hollow central hole for holding a miniature lens therein; a winding element being externally provided around the lens holder; at least one plate-shaped spring element having an outer fixed portion and an inner movable portion to define a hollow center corresponding to the axial central hole of the lens holder; and a housing covering the frame, the magnetic elements, the lens holder, the winding element, and the spring element therein; the housing structure being characterized in that the housing has a top formed into a stepped structure, so that the housing has a size-reduced topmost portion relative to the rest rear portion thereof and has a shoulder portion formed therein to define a predetermined distance between the shoulder portion and the topmost portion, and that the spring element is directly internally connected to the shoulder portion in the housing to keep away from the topmost portion of the housing by the predetermined distance, so that an operation space is formed between the topmost portion of the housing and the spring element, allowing the lens to axially linearly move within the operation space.

2. The housing structure for lens focus module as claimed in claim 1, wherein the spring element is connected at the outer fixed portion to the shoulder portion in the housing.

3. The housing structure for lens focus module as claimed in claim 1, wherein the spring element is connected at the inner movable portion to the lens holder, so as to elastically movably suspend the lens holder in the frame at a center thereof, allowing the lens holder and accordingly the lens to move forward and rearward within the operation space.

4. The housing structure for lens focus module as claimed in claim 1, wherein the housing is made of a metal material to protectively cover the whole lens focus module therein, so as to prevent electromagnetic interference and achieve the purpose of electrostatic protection.

5. The housing structure for lens focus module as claimed in claim 1, wherein the lens focus module further includes a lower cover for assembling to an open bottom of the housing.
